(19) United States
(12) Patent Application Publication
(10) Pub. No.: US 2021/0220901 A1
(43) Pub. Date: Jul. 22, 2021

(54) METHOD FOR MANUFACTURING STEERING SHAFT OF STEERING DEVICE

(71) Applicant: HITACHI AUTOMOTIVE SYSTEMS, LTD., Hitachinaka-shi, Ibaraki (JP)

(72) Inventors: Keisuke KITAMURA, Atsugi-shi, Kanagawa (JP); Tatsuyoshi MARUYAMA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/967,208

(22) PCT Filed: Jan. 28, 2019
(86) PCT No.: PCT/JP2019/002710

§ 371 Date: Aug. 4, 2020

(30) Foreign Application Priority Data
Mar. 12, 2018 (JP) 2018-043774

(51) Int. Cl. B21H 3/04

(52) U.S. Cl. CPC B21H 3/04; B62D 7/20

(57) ABSTRACT

A method for manufacturing a steering shaft of a steering device includes: a reduced-diameter section forming process in which a second-phase member is formed from a first-phase member by forming a reduced-diameter section in the first-phase member; and a ball screw groove forming process in which a third-phase member is formed from the second-phase member by forming a ball screw groove in the second-phase member by rolling.

### TECHNICAL FIELD

The present invention relates to a steering shaft of a steering device, and especially relates to a method for manufacturing the steering shaft by rolling.

### BACKGROUND ART

Patent Document 1 (JP 2001-269741 A) discloses a background art in the present technical field, which is a method for manufacturing a ball screw shaft. The manufacturing method according to Patent Document 1 is to form a thread groove on the ball screw shaft by rolling. The manufacturing method includes: disposing support bushes to support a shaft material, on both sides of a pair of rolling rolls (i.e. rolling dies) disposed oppositely to each other across the shaft material; passing the shaft material through the rolling rolls, while rotating the shaft material; and disposing a support blade to support a rolling minor-diameter portion of the shaft material, in front of the rolling rolls. The support blade is structured retractable, and is retracted in response to detection of a larger-diameter portion of the shaft material by a sensor (see Abstract). The ball screw shaft according to Patent Document 1 has a shape of stepped shaft, and includes the larger-diameter portion and a smaller-diameter portion. The smaller-diameter portion includes a thread spreading within a part of or all over the smaller-diameter portion (see paragraph 0015). Furthermore, according to Patent Document 1, the shaft material is moved in its axial direction while supported by the support bushes disposed in front of the rolling rolls, and the rolling operation starts when a tip of the shaft material reaches the rolling rolls (see paragraph 0020 and FIG. 4). Accordingly, the thread is formed from the tip of the ball screw shaft toward the larger-diameter portion.

### PRIOR ART DOCUMENT(S)

### Patent Document(s)

Patent Document 1: JP 2001-269741 A

### SUMMARY OF THE INVENTION

### Problem(s) to be Solved by the Invention

According to the method for manufacturing the ball screw shaft, the thread is formed from the tip of the ball screw shaft toward the larger-diameter portion. This makes it difficult to grasp the tip of the ball screw shaft by a chuck (i.e. chucking) upon a working process of the shaft material (or the ball screw shaft) after the thread groove has been formed. The following description refers to the thread groove as a ball screw groove, and refers to the ball screw shaft as a steering shaft.

In view of the foregoing, it is desirable to provide a method for manufacturing a steering shaft which facilitates chucking.

### Means for Solving the Problem(s)

According to one aspect of the present invention, a steering device is configured as follows.

A method for manufacturing a steering shaft of a steering device according to one aspect of the present invention includes: a reduced-diameter section forming process in which a second-phase member is formed from a first-phase member 10M by forming a reduced-diameter section in the first-phase member 10M; and a ball screw groove forming process in which a third-phase member is formed from the second-phase member by forming a ball screw groove in the second-phase member by rolling.

### Effect(s) of the Invention

A method for manufacturing a steering shaft according to the present invention serves to provide a method for manufacturing a steering shaft which facilitates chucking.

### BRIEF DESCRIPTION OF THE DRAWINGS

FIG. 1 is a schematic view of a steering system according to an embodiment of the present invention.

FIG. 2 is a plane view showing an appearance of a power steering device according to the embodiment of the present invention.

FIG. 3 is a perspective view of power steering device 1 with housings 30A to 30D removed.

FIG. 4 is an illustrative view of structure to support a steering shaft 10.

FIG. 5A is a perspective view showing an end of a ball screw groove of the steering shaft according to the present invention.

FIG. 5B is a perspective view showing an end of a ball screw groove of a steering shaft 10′ according to a first comparative example with respect to the present invention.

FIG. 5C is a perspective view showing an end of a ball screw groove of a steering shaft 10″ according to a second comparative example with respect to the present invention.

FIG. 6 is a flow chart of main processes for manufacturing the steering shaft 10 including a reduced-diameter section 10e.

FIG. 7 is an illustrative view showing changes from a material 10M to steering shaft 10, along the flow chart of FIG. 6.

FIG. 8 is a schematic view of a second-phase member 10M2 that has been produced by forming the reduced-diameter section 10e in material 10M (i.e. a first-phase member 10M) of steering shaft 10.

FIG. 9 is a configuration view of a ball screw groove machining device 200 structured to form a ball screw groove 10c in second-phase member 10M2.

FIG. 10 is an illustrative view showing a state of an incomplete screw portion RA_X and a state of a complete screw portion RA_10c.

### MODE(S) FOR CARRYING OUT THE INVENTION

The following describes a power steering device including a steering shaft according to an embodiment of the present invention, with reference to the drawings. Power steering device 1 according to the embodiment of the present invention serves to reduce a steering power required of a driver, by transmitting drive force from an electric motor 40 to a steering shaft 10 via a screw mechanism 26.

### [First Embodiment] the Following Describes Power Steering Device 1 According to the First Embodiment

<Configurations of Power Steering Device>

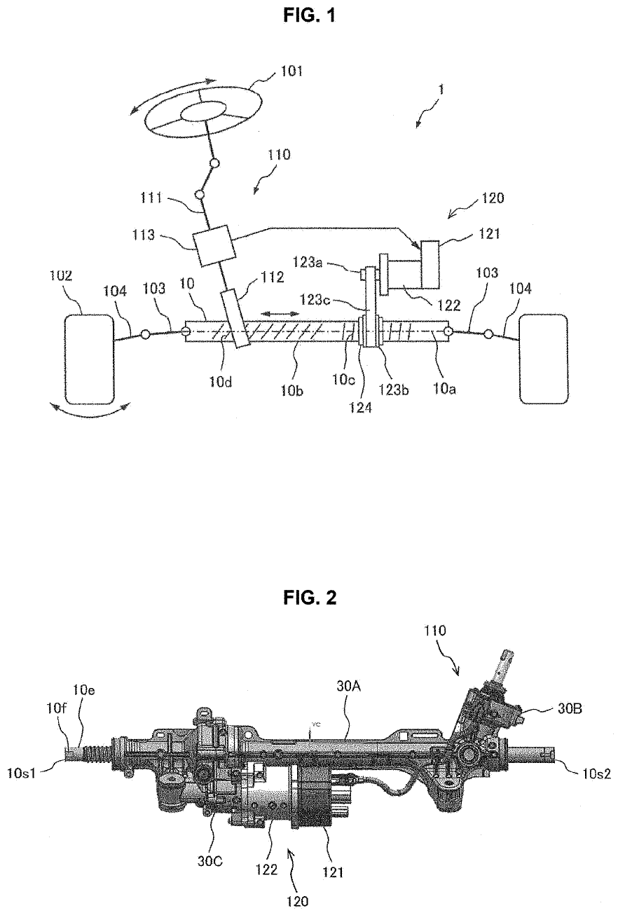

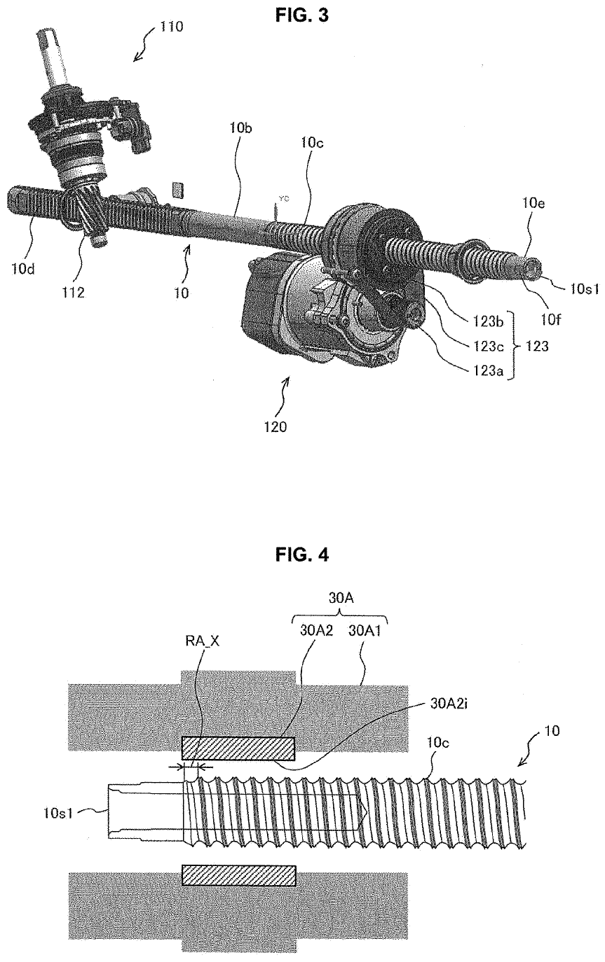

FIG. 1 shows a steering system according to the embodiment of the present invention. FIG. 2 shows an appearance of power steering device 1 according to the embodiment of the present invention. FIG. 3 shows in perspective view the power steering device 1 with housings 30A to 30D removed.

Power steering device 1 includes a steering mechanism 110 and an assist mechanism 120. Steering mechanism 110 transmits rotation of a steering wheel 101 operated by a driver, to steering shaft 10 structured to turn steered wheels 102. Assist mechanism 120 provides assist force with steering shaft 10.

The following description refers to an axis as a first reference axis, wherein the axis is parallel with a longitudinal direction of steering shaft 10 and extends through a center of steering shaft 10 at a cross section perpendicular to the longitudinal direction of steering shaft 10. In other words, the first reference axis is a central line longitudinally extending through the center of the cross section of steering shaft 10. Steering shaft 10 has a radius measured as one from the first reference axis to an outer circumference of steering shaft 10, wherein a radial direction thereof is perpendicular to the first reference axis.

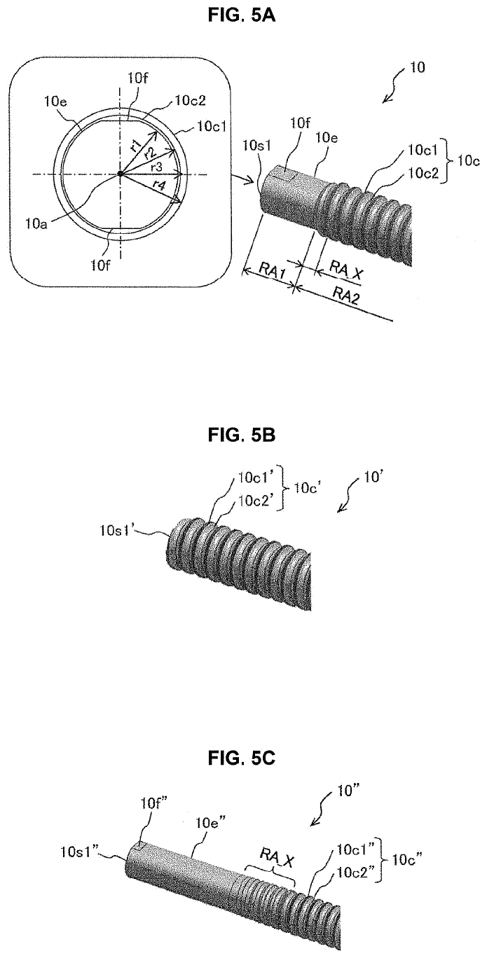

Steering shaft 10 is formed from a rod material 10M (i.e. a first-phase member 10M) made of metal (see FIG. 5), as described below. The following description refers to an axis as a second reference axis, wherein the axis is parallel with a longitudinal direction of first-phase member 10M and extends through a center of first-phase member 10M at a cross section perpendicular to the longitudinal direction. First-phase member 10M has a material radius measured as one from the second reference axis to an outer circumference of first-phase member 10M, wherein a radial direction thereof is perpendicular to the second reference axis.

According to the present embodiment, the first reference axis and the second reference axis are identical with each other. Accordingly, the following description refers to the reference axes as a reference axis 10a simply.

Steering shaft 10 includes a steering shaft body 10b and a ball screw groove 10c of steering shaft side which is formed in steering shaft body 10b. Steering shaft 10 is structured to turn steered wheels 102 due to movement of steering shaft body 10b in a longitudinal direction of steering shaft body 10b (i.e. in a direction of reference axis 10a).

Steering mechanism 110 includes: a steering input shaft 111 connected to steering wheel 101; a pinion 112 structured to rotate together with steering input shaft 111; and a torque sensor 113 structured to monitor a steering torque from a driver. Pinion 112 engages with a rack 10d formed in an outer periphery of steering shaft 10.

Assist mechanism 120 calculates the assist force for steering shaft 10 by an electronic control unit (ECU) 121, based on signal from torque sensor 113, and controls an electric motor 122.

Power steering device 1 includes housings such as housings 30A, 30B, and 30C to contain components of power steering device 1. Housings 30A, 30B, and 30C are composed of a steering shaft container 30A containing the steering shaft 10, and a pinion container 30B containing the pinion 112, and a speed reducer container 30C containing a speed reducer 123. Steering shaft container 30A is a steering shaft housing containing at least a part of steering shaft 10, while maintaining the steering shaft 10 movable in the direction of reference axis 10a. Pinion container 30B is a pinion housing containing the pinion 112 together with torque sensor 113. Speed reducer container 30C is a speed reducer housing surrounding the steering shaft 10 and containing the speed reducer 123.

Speed reducer 123 includes an input pulley 123a, an output pulley 123b, and a belt 123c. Input pulley 123a is structured to rotate integrally with a shaft of electric motor 122. Output pulley 123b is structured to rotate integrally with a nut 124, wherein nut 124 forms a screw mechanism with ball screw groove 10c of steering shaft 10. Belt 123c is wound around and between input pulley 123a and output pulley 123b.

Nut 124 is formed annular to surround steering shaft 10, and is structured rotatable with respect to steering shaft 10. Nut 20 includes in its inner periphery a helical groove serving as a ball screw groove of nut side. Ball screw groove 10c of steering shaft 10 is a helical groove coiling around and extending along reference axis 10a, which is positioned apart from rack 10d in the direction of reference axis 10a.

In a state that steering shaft 10 is inserted in nut 124, ball screw groove 10c of steering shaft 10 forms a ball circulation groove with the ball screw groove of nut 124. The ball circulation groove is filled with metal balls. The balls move in the ball circulation groove, in response to rotation of nut 124. This causes steering shaft 10 to move with respect to nut 124 in the direction of reference axis 10a.

Steering shaft 10 has a pair of ends each of which is connected to a tie rod 103. Each of tie rods 103 is connected to a steering knuckle arm 104. Each of steering knuckle arms 104 supports a corresponding one of steered wheels 102.

FIG. 4 schematically shows structure to support steering shaft 10.

Steering shaft container 30A of power steering device 1 includes a housing body 30A1 and a steering shaft supporter 30A2. Housing body 30A1 is shaped tubular, and is structured to contain steering shaft 10. Steering shaft supporter 30A2 is formed in an inner periphery of housing body 30A1, and includes an inner peripheral surface 30A2i facing the ball screw groove 10c of steering shaft 10. In other words, steering shaft supporter 30A2 is disposed to overlap with ball screw groove 10c in the direction of reference axis 10a.

Steering shaft supporter 30A2 is structured to regulate displacement of steering shaft 10 in a warp direction of steering shaft 10, by contacting with ball screw groove 10c. In view of this, it is desirable to form steering shaft supporter 30A2 in a region to overlap with ball screw groove 10c. This serves to secure a stroke of ball screw mechanism, while suppressing increase in size of power steering device 1 in the direction of reference axis 10a.

The following details ball screw groove 10c of steering shaft 10 according to the present invention.

FIG. 5A is a perspective view showing an end of ball screw groove of steering shaft according to the present invention, which is accompanied by a plane view of steering shaft 10 at a plane perpendicular to reference axis 10a. The plane view perpendicular to reference axis 10a is schematically drawn ignoring the helical shape of ball screw groove 10c, in view of clarification of relation among a reduced-diameter section 10e, a pair of parallel faces 10f, a thread ridge 10c1 of ball screw groove 10c, and a groove bottom 10c2 of ball screw groove 10c.

As shown in FIG. 5A, steering shaft 10 according to the present invention includes the reduced-diameter section 10e and the pair of parallel faces 10f formed in reduced-diameter section 10e. Steering shaft 10 is formed from rod material 10M (i.e. first-phase member 10M) made of metal (see FIG. 5). Steering shaft 10 includes a pair of ends: a first end 10s1 and a second end 10s2. Reduced-diameter section 10e is formed at first end 10s1, in a predetermined region RA1 (i.e. a first region RA1) including first end 10s1.

Ball screw groove 10c is formed in a second region RA2 being a predetermined region outside of first region RA1 in the direction of reference axis 10a. According to the present embodiment, second region RA2 spreads toward second end 10s2 of steering shaft 10 from an end of first region RA1 which is a nearer one to second end 10s2 out of ends of first region RA1.

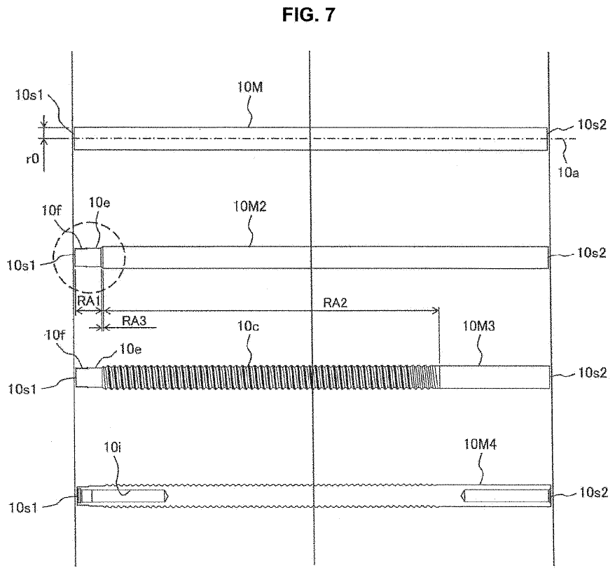

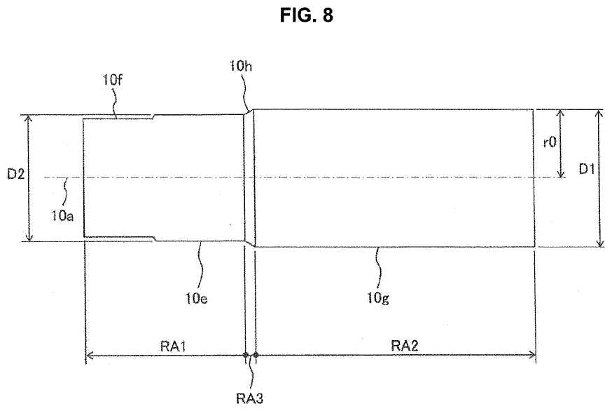

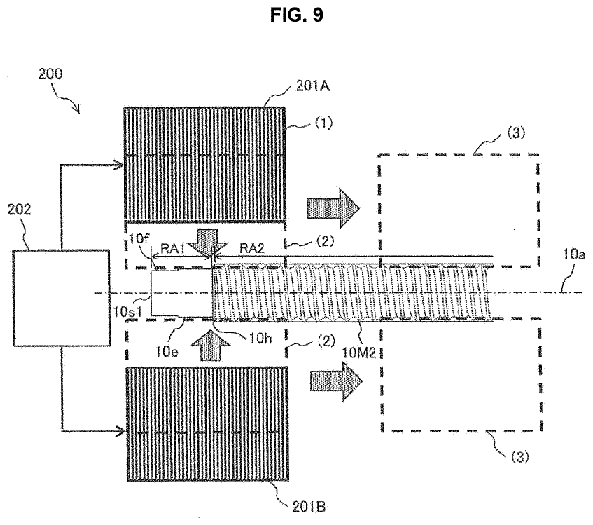

Reduced-diameter section 10e has a radius r1 measured from reference axis 10a, wherein radius r1 is smaller than a radius r4 of thread ridge 10c1 of ball screw groove 10c. Although material 10M of steering shaft 10 has a radius r0 (see FIGS. 7 and 8) approximately equal to radius r4 of thread ridge 10c1, radius r4 of thread ridge 10c1 is larger than radius r0 of material 10M due to material flowing during rolling operation. On the other hand, reduced-diameter section 10e is smaller than radius r0 of material 10M of steering shaft 10.

In reduced-diameter section 10e, each of parallel faces 10f is formed to spread from first end 10s1 toward second end 10s2 in the direction of reference axis 10a. According to the present embodiment, the pair of parallel faces 10f are disposed symmetrically across reference axis 10a. In other words, when viewed in a circumferential direction of reduced-diameter section 10e around reference axis 10a, the pair of parallel faces 10f are disposed 180° away from each other in angle around reference axis 10a. Each of the pair of parallel faces 10f is parallel with reference axis 10a, and therefore the pair of parallel faces 10f are parallel with each other.

Groove bottom 10c2 of ball screw groove 10c has a radius r2 equal to or larger than radius r1 of reduced-diameter section 10e, in order to avoid forming the ball screw groove 10c (especially, groove bottom 10c2) in reduced-diameter section 10e upon rolling operation. Actually, radius r2 of groove bottom 10c2 is set larger than radius r1 of reduced-diameter section 10e, for certainty of the avoidance of forming the ball screw groove 10c. Furthermore, radius r2 of groove bottom 10c2 of ball screw groove 10c is necessarily smaller than radius r4 of thread ridge 10c1 of ball screw groove 10c, and smaller than radius r0 of material 10M of steering shaft 10.

FIG. 5A exemplifies second region RA2 as spreading from the end of first region RA1 toward second end 10s2 of steering shaft 10. However, as shown in FIG. 8, steering shaft 10 may include a taper portion 10h between first region RA1 and second region RA2 in the direction of reference axis 10a, wherein taper portion 10h increases in diameter, from first region RA1 to second region RA2. In this case, steering shaft 10 has a third region RA3 between first region RA1 and second region RA2 in the direction of reference axis 10a. Third region RA3 includes taper portion 10h that gradually increases in radius measured from reference axis 10a, as followed in the direction from first region RA1 to second region RA2.

Taper portion 10h is formed during manufacture of steering shaft 10, and in some cases, may be almost eliminated in finished steering shaft 10. In more precise sense, it may be difficult to distinguish the taper portion of third region RA3 from second region RA2 including ball screw groove 10c, in case that a difference between radius r2 of groove bottom 10c2 of ball screw groove 10c and radius r1 of reduced-diameter section 10e is small.

Furthermore, second region RA2 includes a region RA_X at its end facing first region RA1, wherein in region RA_X the groove is formed incompletely. This makes it more difficult to distinguish third region RA3 from second region RA2.

The following describes a first end and a second end of material 10M of steering shaft 10 as respectively identical to first end 10s1 and second end 10s2 of steering shaft 10. Thus, material 10M of steering shaft 10 is described as including first end 10s1 and second end 10s2. However, each of first end 10s1 and second end 10s2 of steering shaft 10 may be formed by applying some processing to first end 10s1 and second end 10s2 of material 10M.

FIG. 5B shows in perspective view an end of a steering shaft 10′ according to a first comparative example with respect to the present invention.

Steering shaft 10′ shown in FIG. 5B is configured such that: reduced-diameter section 10e according to the present embodiment is not formed; and ball screw groove 10c is formed from first end 10s1′ of material 10M of steering shaft 10 by rolling. Thus, ball screw groove 10c′ (i.e. thread ridge 10c1 and groove bottom 10c2) is formed from first end 10s1′ of material 10M of steering shaft 10 toward an opposite end. This causes chucking for tie rod to be performed on ball screw groove 10c′, and thereby makes the chucking for tie rod more difficult. Alternatively, in case of forming the parallel faces 10f according to the present embodiment for chucking of tie rod 103, parallel faces 10f are to be formed in ball screw groove 10c′. This makes the forming of parallel faces 10f more difficult.

FIG. 5C shows in perspective view an end of a steering shaft 10″ according to a second comparative example with respect to the present invention.

FIG. 5C exemplifies steering shaft 10″ in which a ball screw groove 10c″ is formed by infeed rolling. In the infeed rolling, ball screw groove 10c″ is formed by longitudinally moving the material 10M while bringing a pair of rotating rolling-dies close to material 10M. This expands a range (i.e. a longitudinal length) RA_X within which the incomplete groove is formed.

The following describes a method for manufacturing the steering shaft 10 including the reduced-diameter section 10e.

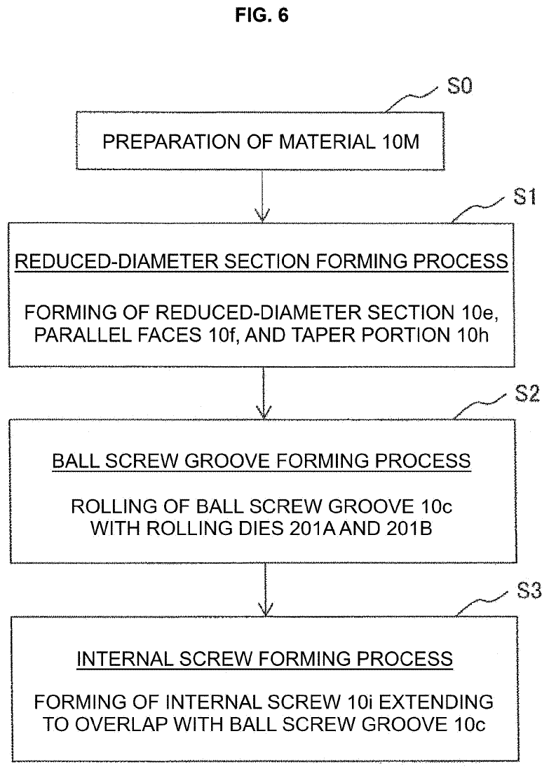

FIG. 6 is a flow chart of main processes for manufacturing the steering shaft 10 including the reduced-diameter section 10e. FIG. 7 is an illustrative view showing changes from material 10M to steering shaft 10, along the flow chart of FIG. 6.

The manufacturing method according to the present embodiment includes a reduced-diameter section forming process S1 (i.e. a first process S1), a ball screw groove forming process S2 (i.e. a second process S2), and an internal screw forming process S3 (i.e. a third process S3).

Antecedently to the reduced-diameter section forming process S1 (first process S1), material 10M of steering shaft 10 is prepared: namely, a step S0. Material 10M of steering shaft 10 is a member at first phase which is a rod made of metal. First-phase member 10M according to the present embodiment is a cylindrical rod constant in outer diameter from first end 10s1 to second end 10s2.

As described above, reference axis 10a is referred to as the axis that is parallel with the longitudinal direction of first-phase member 10M and extends through the center of first-phase member 10M at the cross section perpendicular to the longitudinal direction. Radius r0 is referred to as the radius of the outer circumference of first-phase member 10M which is measured from reference axis 10a.

The reduced-diameter section forming process S1 (first process S1) includes forming the reduced-diameter section 10e in first region RA1 being the predetermined region including first end 10s1, wherein material 10M includes first end 10s1 and second end 10s2 as the pair of ends in the longitudinal direction. Reduced-diameter section 10e has the radius measured from reference axis 10a which is smaller than radius r0 of material 10M (i.e. first-phase member 10M). The reduced-diameter section forming process S1 to form reduced-diameter section 10e yields a second-phase member 10M2.

In the reduced-diameter section forming process S1, reduced-diameter section 10e (or a smaller-diameter section 10e) is formed in first-phase member 10M. Thus, reduced-diameter section 10e has a diameter D2 smaller than a diameter D1 of material 10M. Material 10M includes a portion outside of reduced-diameter section 10e, which serves as a larger-diameter portion 10g with respect to reduced-diameter section 10e (smaller-diameter section 10e).

FIG. 8 shows second-phase member 10M2 that has been produced by forming the reduced-diameter section 10e in material 10M (first-phase member 10M) of steering shaft 10.

Second-phase member 10M2 includes third region RA3 formed between first region RA1 and second region RA2 in the direction of reference axis 10a. Third region RA3 includes taper portion 10h, wherein taper portion 10h gradually increases in radius measured from reference axis 10a, as followed in the direction from first region RA1 to second region RA2.

Third region RA3, which is formed between first region RA1 and second region RA2 and includes taper portion 10h, serves to improve the ball screw groove forming process S2 to form ball screw groove 10c, in engagement between material 10M and the rolling dies. This improves ball screw groove 10c in accuracy of machining.

Taper portion 10h of third region RA3 may be formed upon forming the reduced-diameter section 10e in the reduced-diameter section forming process S1. In other manner, taper portion 10h of third region RA3 may be formed in another process after the reduced-diameter section forming process S1 in which reduced-diameter section 10e has been formed. Each of reduced-diameter section 10e of first region RA1 and taper portion 10h of third region RA3 can be formed by grinding, exemplarily.

After forming the reduced-diameter section 10e, or forming the reduced-diameter section 10e and taper portion 10h, parallel faces 10f are formed. The forming of reduced-diameter section 10e, the forming of taper portion 10h, and the forming of parallel faces 10f may be implemented in any order. Furthermore, the forming of parallel faces 10f may be implemented after the ball screw groove forming process S2 (second process S2) described below.

FIG. 9 shows configurations involving a ball screw groove machining device 200 structured to form ball screw groove 10c in second-phase member 10M2.

Ball screw groove machining device 200 includes a pair of rolling dies 201A and 201B and a drive unit 202 for rolling dies 201A and 2018. Rolling dies 201A and 2018 are disposed to interpose second-phase member 10M2 therebetween in a direction perpendicular to reference axis 10a, wherein second-phase member 10M2 is a material in which ball screw groove 10c is formed.

Each of rolling dies 201A and 201B includes a helical projection for rolling operation of ball screw groove 10c. Ball screw groove 10c is formed in second-phase member 10M2 by sandwiching the second-phase member 10M2 between rolling dies 201A and 201B from both sides in the direction perpendicular to reference axis 10a.

The ball screw groove forming process S2 (second process S2) includes: moving the rolling dies 201A and 201B from a position (1) apart from second-phase member 10M2 to a position (2) close to second-phase member 10M2; and then moving the rolling dies 201A and 201B from the position (2) to a position (3) in a direction from first end 10s1 to second end 10s2 of second-phase member 10M2 (see FIG. 7), parallel with reference axis 10a. On this occasion, rolling dies 201A and 201B rotate and move from position (1) to position (3) under control of drive unit 202.

Thus, in the ball screw groove forming process S2 (second process S2), ball screw groove machining device 200 shown in FIG. 9 forms ball screw groove 10c in second-phase member 10M2, and yields a third-phase member 10M3. Ball screw groove 10c is formed in second region RA2 being the predetermined region outside of first region RA1 in the direction of reference axis 10a. Third-phase member 10M3 is produced by forming the ball screw groove 10c by rolling in second region RA2 of second-phase member 10M2.

According to the present embodiment, reduced-diameter section 10e in first region RA1 has a smooth cylindrical periphery (or a smooth cylindrical tubular surface), because ball screw groove 10c is formed in second region RA2. Reduced-diameter section 10e does not include ball screw groove 10c. This facilitates performing the chucking for tie rod 103 on reduced-diameter section 10e, and forming the pair of parallel faces 10f parallel with reference axis 10a for the chucking for tie rod 103. Parallel faces 10f are formed apart from each other in the direction perpendicular to reference axis 10a.

International Patent Classification File Index B21H 8/00 includes art for rolling operation. International Patent Classification File Index: F16D 1/076 includes two faces perpendicular to the axis of rotation, which corresponds to the pair of parallel faces 10f apart from each other in the direction perpendicular to reference axis 10a.

As shown in FIG. 9, in the ball screw groove forming process S2 (second process S2), the rolling operation is started with rolling dies 201A and 201B pressed on second-phase member 10M2 such that each of rolling dies 201A and 201B overlaps with both of first region RA1 and second region RA2 in the direction of reference axis 10a. This serves to reduce increase in spread of incomplete screw portion RA_X (see FIGS. 4 and 5A) in second region RA2, in comparison with a case of starting the rolling operation with rolling dies 201A and 201B pressed on only second region RA2.

International Patent Classification File Index B23G 7/02 includes rolling dies as a supplementary explanation.

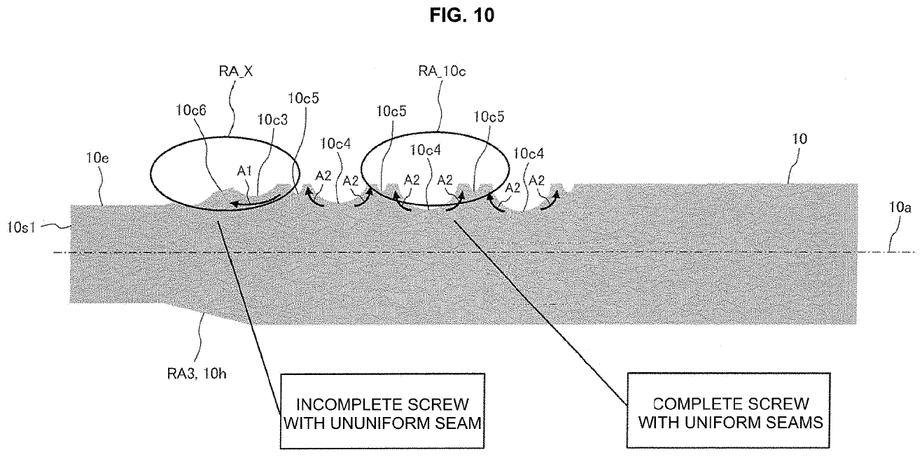

FIG. 10 shows a state of incomplete screw portion RA_X and a state of a complete screw portion RA_10c.

Upon the rolling operation of ball screw groove 10c in second-phase member 10M2 with rolling dies 201A and 2018, incomplete screw portion RA_X is formed at a ball screw groove 10c3 due to flowing of material toward reduced-diameter section 10e (see an arrow A1), wherein ball screw groove 10c3 is at an end of ball screw groove 10c closer to reduced-diameter section 10e than another end, in the direction of reference axis 10a. On the other hand, at a ball screw groove 10c4 apart from the end closer to reduced-diameter section 10e, the material flows to form a thread ridge (see arrows A2) and yields uniform seams 10c5. Incomplete screw portion RA_X corresponds to a region in which forming of complete ball screw groove 10c4 has not been started yet, and incomplete ball screw groove 10c3 is formed. Thus, incomplete screw portion RA_X includes a seam 10c6 that may be ununiform and sharp-edged. When sharp-edged, seam 10c6 may interfere with steering shaft supporter 30A2 (see FIG. 4) and damage it.

In view of the foregoing, the present embodiment is configured to form ball screw groove 10c such that third-phase member 10M3 includes incomplete screw portion RA_X in third region RA3. Thus, incomplete screw portion RA_X is formed in third region RA3 smaller in diameter than the region in which complete ball screw groove 10c4 is formed. This serves to suppress incomplete screw portion RA_X from being formed in second region RA2. This reduces the damage to steering shaft supporter 30A2 even in the configuration that steering shaft supporter 30A2 supports ball screw groove 10c of steering shaft 10.

The incomplete screw portion corresponds to an incomplete screw in JIS (Japanese Industrial Standards) B1006 or in ISO (International Organization for Standardization) 3353.

The following description is based on FIGS. 6 and 7 again.

The manufacturing method of steering shaft 10 according to the present embodiment includes the internal screw forming process S3 (third process S3). The internal screw forming process S3 may be referred to also as an inner diameter machining process. The internal screw forming process S3 is implemented after the ball screw groove forming process S2, and includes forming an internal screw 10i open at first end 10s1 of third-phase member 10M3. Steering shaft 10 is finished after the internal screw forming process S3.

Internal screw 10i is structured to connect steering shaft 10 to tie rod 103, in combination with an external screw formed in tie rod 103 (or formed in a ball joint in tie rod 103). Internal screw 10i is exemplarily formed after the rolling operation of ball screw groove 10c in the ball screw groove forming process S2. This serves to reduce deterioration in machining accuracy of ball screw groove 10c. In detail, in case of forming the ball screw groove 10c after forming the internal screw 10i in second-phase member 10M2, the machining accuracy of ball screw groove 10c may be deteriorated due to deformation of second-phase member 10M2 upon the rolling operation, because of reduced rigidity of second-phase member 10M2 in a portion in which internal screw 10i is formed. Accordingly, the deterioration in machining accuracy of ball screw groove 10c can be reduced by forming the internal screw 10i after accurately forming the ball screw groove 10c in second-phase member 10M2.

Tie rod 103 corresponds to a tie rod in File forming term list: 3D034 BC25.

As shown in FIG. 7, internal screw 10i extends overlap with ball screw groove 10c in the direction of reference axis 10a. This serves to suppress steering shaft 10 from increasing in size in the direction of reference axis 10a (i.e. axial size), while securing an enough region for forming the internal screw 10i. In steering shaft 10 including the internal screw 10i extending to overlap with ball screw groove 10c, the rolling operation of ball screw groove 10c after forming the internal screw 10i may increase deformation of components and deteriorate the machining accuracy of ball screw groove 10c. However, the deterioration in machining accuracy of ball screw groove 10c is reduced by forming the internal screw 10i after accurately forming the ball screw groove 10c.

The following exemplifies favorable aspects of a method for manufacturing a steering shaft of a steering device, according to the embodiment described above.

A method for manufacturing a steering shaft of a steering device according to one aspect thereof includes: a reduced-diameter section forming process in which a second-phase member is formed from a first-phase member being a metal rod, by forming a reduced-diameter section in the first-phase member; and a ball screw groove forming process in which a third-phase member is formed from the second-phase member by forming a ball screw groove in the second-phase member, wherein: the reduced-diameter section has a radius measured from a reference axis which is smaller than a material radius, wherein the reference axis is an axis that is parallel with a longitudinal direction of the first-phase member and extends through a center of the first-phase member at a cross section perpendicular to the longitudinal direction of the first-phase member, and wherein the material radius is a radius of an outer circumference of the first-phase member which is measured from the reference axis; in the reduced-diameter section forming process, the reduced-diameter section is formed in a first region that is a predetermined region including a first end of the first-phase member, wherein the first-phase member includes the first end and a second end in the longitudinal direction of the first-phase member; and in the ball screw groove forming process, the ball screw groove is formed in a second region of the second-phase member by rolling, wherein the second region is a predetermined region outside of the first region in a direction of the reference axis.

According to a favorable aspect of the manufacturing method, in the ball screw groove forming process, the rolling of the ball screw groove is started from a state that rolling dies are pressed on the second-phase member such that each of the rolling dies overlaps with both of the first region and the second region in the direction of the reference axis.

According to another favorable aspect of the manufacturing method, in any aspect of the manufacturing method: the steering device includes a steering shaft housing; the steering shaft housing includes a body and a steering shaft supporter; the body has a tubular shape and is structured to contain the steering shaft; and the steering shaft supporter is formed in an inner periphery of the body, and is structured to contact with the ball screw groove so as to regulate displacement of the steering shaft in a warp direction of the steering shaft.

According to still another favorable aspect of the manufacturing method, in any aspect of the manufacturing method: the second-phase member includes a third region between the first region and the second region in the direction of the reference axis; and the second-phase member includes in the third region a taper portion increasing gradually in radius measured from the reference axis, as followed in a direction from the first region to the second region.

According to still another favorable aspect of the manufacturing method, in any aspect of the manufacturing method, the third-phase member includes an incomplete screw portion in the second region.

According to still another favorable aspect of the manufacturing method, in any aspect of the manufacturing method, the manufacturing method further includes an internal screw forming process in which an internal screw is formed to open at the first end, wherein the internal screw forming process is implemented after the ball screw groove forming process.

According to still another favorable aspect of the manufacturing method, in any aspect of the manufacturing method, the internal screw extends to overlap with the ball screw groove in the direction of the reference axis.

1. A method for manufacturing a steering shaft of a steering device, the method comprising:
a reduced-diameter section forming process in which a second-phase member is formed from a first-phase member being a metal rod, by forming a reduced-diameter section in the first-phase member; and
a ball screw groove forming process in which a third-phase member is formed from the second-phase member by forming a ball screw groove in the second-phase member,
wherein:
the reduced-diameter section has a radius measured from a reference axis which is smaller than a material radius, wherein the reference axis is an axis that is parallel with a longitudinal direction of the first-phase member and extends through a center of the first-phase member at a cross section perpendicular to the longitudinal direction of the first-phase member, and wherein the material radius is a radius of an outer circumference of the first-phase member which is measured from the reference axis;
in the reduced-diameter section forming process, the reduced-diameter section is formed in a first region that is a predetermined region including a first end of the first-phase member, wherein the first-phase member includes the first end and a second end in the longitudinal direction of the first-phase member; and
in the ball screw groove forming process, the ball screw groove is formed in a second region of the second-phase member by rolling, wherein the second region is a predetermined region outside of the first region in a direction of the reference axis.

2. The method as claimed in claim 1, wherein in the ball screw groove forming process, the rolling of the ball screw groove is started from a state that rolling dies are pressed on the second-phase member such that each of the rolling dies overlaps with both of the first region and the second region in the direction of the reference axis.

3. The method as claimed in claim 1, wherein:
the steering device includes a steering shaft housing;
the steering shaft housing includes a body and a steering shaft supporter;
the body has a tubular shape and is structured to contain the steering shaft; and
the steering shaft supporter is formed in an inner periphery of the body, and is structured to contact with the ball screw groove so as to regulate displacement of the steering shaft in a warp direction of the steering shaft.

4. The method as claimed in claim 1, wherein:
the second-phase member includes a third region between the first region and the second region in the direction of the reference axis; and
the second-phase member includes in the third region a taper portion increasing gradually in radius measured from the reference axis, as followed in a direction from the first region to the second region.

5. The method as claimed in claim 1, wherein the third-phase member includes an incomplete screw portion in a third region between the first region and the second region in the direction of the reference axis.

6. The method as claimed in claim 1, the method further comprising:
an internal screw forming process in which an internal screw is formed to open at the first end,
wherein the internal screw forming process is implemented after the ball screw groove forming process.

7. The method as claimed in claim 6, wherein the internal screw extends to overlap with the ball screw groove in the direction of the reference axis.
